(19) United States
(12) Patent Application Publication
(10) Pub. No.: US 2017/0031461 A1
(43) Pub. Date: Feb. 2, 2017

(54) DYNAMIC INPUT DEVICE FOR PROVIDING AN INPUT AND METHOD THEREOF

(71) Applicant: Infosys Limited, Bangalore (IN)

(72) Inventors: Akshay Darbari, Allahabad (IN); Puneet Gupta, Bangalore (IN)

(21) Appl. No.: 15/156,444

(22) Filed: May 17, 2016

(30) Foreign Application Priority Data
Jun. 3, 2015 (IN) 2785/CHE/2015

(51) Int. Cl. G06F 3/023; G06F 3/0488

(52) U.S. Cl. CPC G06F 3/0237; G06F 3/04886

(57) ABSTRACT

The technique relates to a dynamic input device for providing an input and method thereof A character as an input is received. The input character as a central character of a virtual grid is arranged. Thereafter, a set of one or more characters towards the center of the virtual grid and adjacent to the central input character is arranged in the virtual grid based on a ranking logic. A required character is selected from the arranged set of one or more characters and the selected required character is replaced as the central character in the virtual grid in the virtual grid. Then another set of one or more characters towards the center of the virtual grid is arranged in the virtual grid in response to the replaced central character along with the input character, based on the ranking logic. Repeating the steps till a predefined word is formed.

This application claims the benefit of Indian Provisional Patent Application Serial No. 2785/CHE/2015, filed Jun. 3, 2015 which is hereby incorporated by reference in its entirety.

### FIELD

This present invention generally relates to an enhanced user interface for providing an input and more particularly to a dynamic input device and method thereof.

### BACKGROUND

Recently, intelligent/smart electronic devices are becoming much more prevalent in homes, businesses, and in day to day activities. Many of these devices require users to input textual data. However, usually the portable nature of these devices makes the use of standard keyboards both undesirable and impracticable. It is often cumbersome to provide inputs on a constraint device like television, mobile phones, tablets, etc. The number of interactions required is equal to number of alphabets for touch devices or traditional keyboard based devices and it is painful and time consuming to key-in or type the keyword/content, it is even more difficult for the arrow key based or number based keypads.

### SUMMARY

The present invention overcomes the limitation mentioned above by providing an input from a dynamic input device wherein input device is context aware predictive and adaptive which focuses on ease of use by minimizing the number of interactions and adaptively and predictively builds the keyword/content, especially very effective for devices for instance television wherein the input is through a remote control.

According to the present embodiment, a method for providing an input from a dynamic input device is disclosed. A character as an input is received from the input device. Then the input character is arranged as a central character of a virtual grid on the input device. Thereafter, a set of one or more characters towards the center of the virtual grid and adjacent to the central input character is arranged in the virtual grid based on a ranking logic. A required character is selected from the arranged set of one or more characters in the virtual grid and replaced as the central character of the virtual grid. Then another set of one or more characters towards the center of the virtual grid is arranged in the virtual grid in response to the replaced central character along with the input character, based on the ranking logic. Repeating the steps till a predefined word is formed.

In an additional embodiment, a non-transitory computer readable medium having stored instructions for providing an input from a dynamic input device is disclosed. A character as an input is received from the input device. Then the input character is arranged as a central character of a virtual grid on the input device. Thereafter, a set of one or more characters towards the center of the virtual grid and adjacent to the central input character is arranged in the virtual grid based on a ranking logic. A required character is selected from the arranged set of one or more characters in the virtual grid and replaced as the central character of the virtual grid. Then another set of one or more characters towards the center of the virtual grid is arranged in the virtual grid in response to the replaced central character along with the input character, based on the ranking logic. Repeating the steps till a predefined word is formed.

In another embodiment, a dynamic input device for providing an input comprising one or more processors and a memory coupled to the one or more processor which are configured to execute programmed instructions stored in the memory is disclosed. A character as an input is received from the input device. Then the input character is arranged as a central character of a virtual grid on the input device. Thereafter, a set of one or more characters towards the center of the virtual grid and adjacent to the central input character is arranged in the virtual grid based on a ranking logic. A required character is selected from the arranged set of one or more characters in the virtual grid and replaced as the central character of the virtual grid. Then another set of one or more characters towards the center of the virtual grid is arranged in the virtual grid in response to the replaced central character along with the input character, based on the ranking logic. Repeating the steps till a predefined word is formed.

### BRIEF DESCRIPTION OF THE DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a flowchart, illustrating a method for providing an input from a dynamic input device, in accordance with an embodiment of the present technique.

FIG. 3 is an exemplary arrangement of plurality of characters in plurality of cells of a square virtual grid for first time usage, in accordance with an embodiment of the present technique.

FIG. 4 is an exemplary depiction of a ranking logic which places a set of one or more characters towards the center of the virtual grid and adjacent to the central input character in plurality of cells a square virtual grid, in accordance with an embodiment of the present technique.

FIG. 5 is an exemplary depiction of an interaction point of each input character as center in a square virtual grid, in accordance with an embodiment of the present technique.

FIG. 6 is an exemplary square virtual grid which depicts equal number of clicks from the center of a square grid, in accordance with an embodiment of the present technique.

FIG. 7 is an exemplary virtual grid predicting plurality of suffixes and placing the suffixes in the blank cells of the square virtual grid in response to the input characters, in accordance with an embodiment of the present technique.

FIG. 8 is an exemplary layouts depicting placement of blank cells depending upon type of devices and mode of interactions by user, in accordance with an embodiment of the present technique.

FIG. 9 depicts an exemplary layout of a circular virtual grid in a keyboard, in accordance with an embodiment of the present technique.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

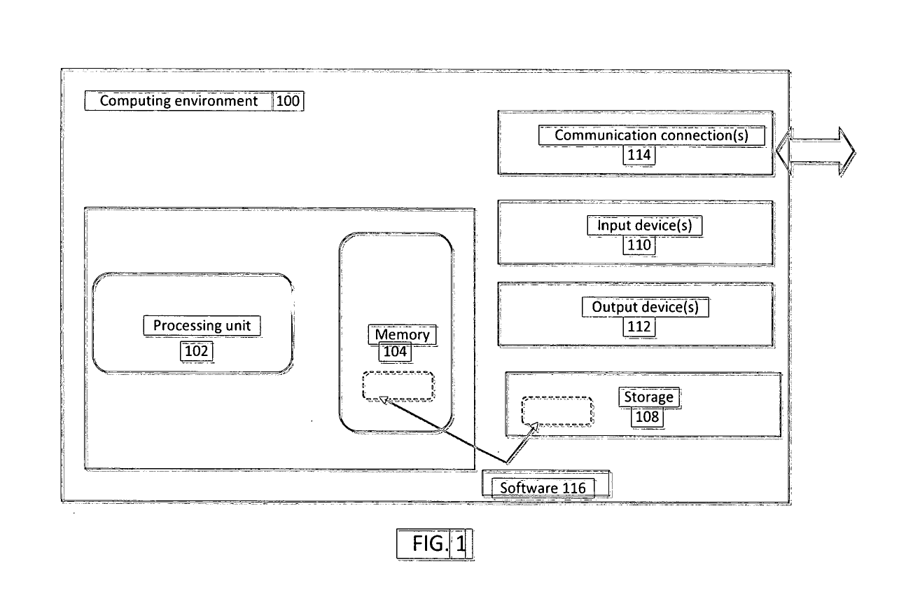

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

According to an embodiment, a dynamic input devices comprises a memory, a processor, an input interface and a display. The processor is configured to predict and provide input through the display. The memory stores a ranking logic which is used by the processor for the prediction of appropriate input characters. The virtual grid arrangement may also be stored in the memory or transient or otherwise, or embedded database at every step.

In another embodiment, the input device may contain a communication interface for connecting with remote locations e.g. a remote server, or a cloud storage. The ranking logic and also the virtual grid arrangement can be stored at a remote location. This will be accessed by the input device when the user tries to provide input using the device.

The communication interface may contain an electronic circuit or wireless channel, usually designed to a specific standard that enables one machine to telecommunicate with another machine.

These predictions by the processor are displayed to the user in a virtual grid. The virtual grid is an array of characters provided to the user to select required characters. As the processor uses the ranking logic to predict the further characters, the virtual grid keeps arranging itself dynamically.

The input device also preferably includes an input interface to navigate through virtual grid displayed to the user. This input interface may include hardware keys.

In another embodiment, the display can be a touch screen for the user to navigate through the virtual grid.

According to further embodiments of this technology, the hardware and software combinations may be one of the following, but not limited to a keypad or keyboard with a display and a dynamic virtual keyboard is displayed on a device. Another combination may be a device just to display soft keypad or keyboard which has a display and a dynamic virtual keyboard is displayed on it. One another combination may be a soft keyboard on a device display and a hardware keyboard with up, down, right, left, enter, and back keys. Further combination may be, a soft keyboard on a device display and a separate soft keyboard which only has up, down, right, left, enter and back keys. Similar such combinations within the scope of the present invention can also be implemented.

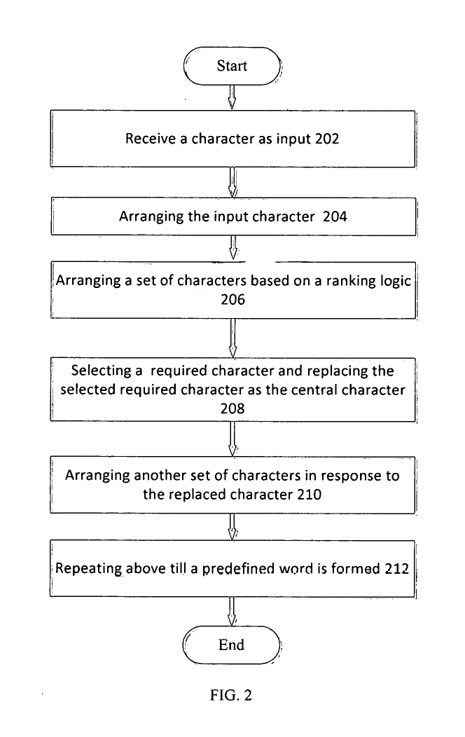

FIG. 2 is a flowchart, illustrating a method for providing an input from a dynamic input device, in accordance with an embodiment of the present technique. In a preferred embodiment, the input device will have a display. In another embodiment, the input device provides input to a device with display eg providing input to a TV, using a remote control.

In a preferred embodiment, the display shows a virtual grid while providing input. The virtual grid refers to means for providing the input into the input device. The virtual grid comprises of plurality of cells wherein a plurality of characters are placed in a specific manner. The specific manner in which a character are placed in the virtual grid depends on the type, shape, size etc. of the input device.

The characters can be arranged initially, but not limited to QWERTY pattern or any other sequential or alphabetical pattern. In one embodiment, the initial arrangement of characters can be configurable by the user.

The user provides a character as an input from the input device 202. The input character may comprise one or more alphabets, numbers, function key and special keys. The input device is not limited to handheld devices, mouse, joystick, remote, keyboard, keypad, touch, non-touch, key based etc. The input character is arranged as a central character of the virtual grid on the input device 204. Thereafter, a set of one or more characters are arranged towards the center of the virtual grid, based on a ranking logic, adjacent to the central input character 206.

In a preferred embodiment, the set of one or more characters can include alphabets, numbers, function key, special keys, prefixes, suffixes, one or more words or one or more sub-words/sub-strings in the virtual grid. The sub words are the words which represents all possible sub-strings (that may include a standard dictionary word acronyms or short forms) that could help form a word.

In one embodiment, the ranking logic calculates the possibility of occurrence of a particular letter and allocates ranks to a plurality of characters, words and sub-words, associated with the input character. The ranking logic determines the probable characters or the set of one or more characters or another set of one or more characters to be arranged in the virtual grid in response to the input character based on but not limited to, one or more combination of dictionary, end user defined keyword, end user frequently used keyword, previously entered word or a sub-word, predictive text analysis, SMS lingo, Twitter lingo etc.

In another embodiment, the probable characters or set of one or more characters are also determined based on context for instance but not limited to Contact book (in case of name), Calendar (in case of date), Address etc or by fetching from online connected programs such as google contacts, yahoo mails etc, which is used as context.

In yet another embodiment, the ranking logic determines the next characters based on the device for which input is provided. Eg for inputs given by remote control to TV, the channel names etc which are used as context.

In a preferred embodiment, the ranking logic is stored in the transient memory or a database or otherwise on the hardware. In another embodiment, the logic resides on the cloud and the keyboard will connect it over the internet and get the data in real tie or at the start of the process.

After arranging the set of one or more characters towards the center of the virtual grid and adjacent to the central input character in the virtual grid, based on the ranking logic, the user selects the next required character from the arranged set of one or more characters in the virtual grid 208. The required character is that character which the user requires to proceed to form a predefined or desired word. Once the required character is selected, the selected required character is replaced as the central character of the virtual grid, thereafter an another set of one or more characters are arranged towards the center of the virtual grid in response to the replaced central character along with the input character based on the ranking logic 210. The each input or selected character act as central character. The another set of one or more characters are probable set of one or more characters which may progress to form the predefined or the desired word. The above steps are repeated till the predefined or desired word is formed 212. The predefined or desired word is a word which the user needs to form in the virtual grid of the input device. In another embodiment, the input device may be a context aware predictive and adaptive keyboard.

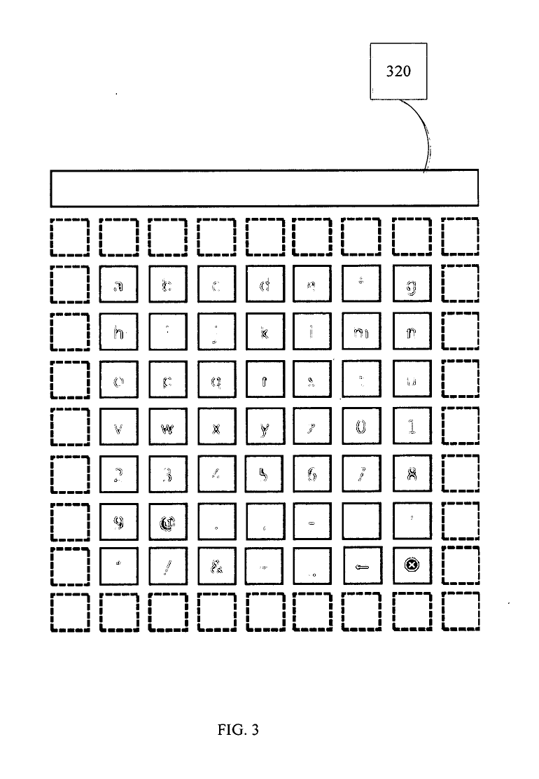

FIG. 3 is an exemplary arrangement of plurality of characters in plurality of cells of a square virtual grid for first time usage i.e. for the user to provide the first input, in accordance with an embodiment of the present technique. The characters on the cells of the virtual grid are arranged in a specific manner for first time usage irrespective of shape of the grid. The arrangement in the specific manner depends upon but not limited to, size, shape etc of the input device. Eg. The arrangement of characters in the cells of the virtual grid may differ in TV remote, mobile keypad. The characters can be arranged initially in QWERTY pattern or any other sequential or alphabetical pattern. In one embodiment, the initial arrangement of characters can be configurable by the user.

The shape of virtual grid and the input device is not limited to square, rectangle, round, circular etc. In FIG. 3 the square virtual grid, an input interface is represented by solid line rectangle 320. The cells of virtual grid is area wherein individual characters are placed. The Input interface is area wherein the input characters are entered and/or displayed. The characters are any compatible inscriptions. The input character is inscription entered through input interface of an input device. The plurality of characters are placed in cells of the grid of input device wherein characters comprises alphabets, numbers, function key and special keys arranged in a specific manner in a grid for first time usage. The virtual grid is balanced by one or more blank cells as represented by dotted line in diagram. The arrangement of characters in the cells of the virtual grid in not limited to sequential arrangement. According to a further embodiment of the technology, the blank cells accommodates one or more words or one or more sub-words/ sub-strings in the virtual grid. The sub words are the words which represents all possible sub-strings (that may include a standard dictionary word acronyms or short forms) that could help form a word. For example, in a banana following are the representations:

prefix: “ban” in a banana
suffix: “nana” in banana
sub-word or a sub-string: “ana” in banana

According to another embodiment of the technology, all the characters are always displayed whether they could form a legitimate or standard word or not. The arrangement of characters would be based on the probability of forming a word.

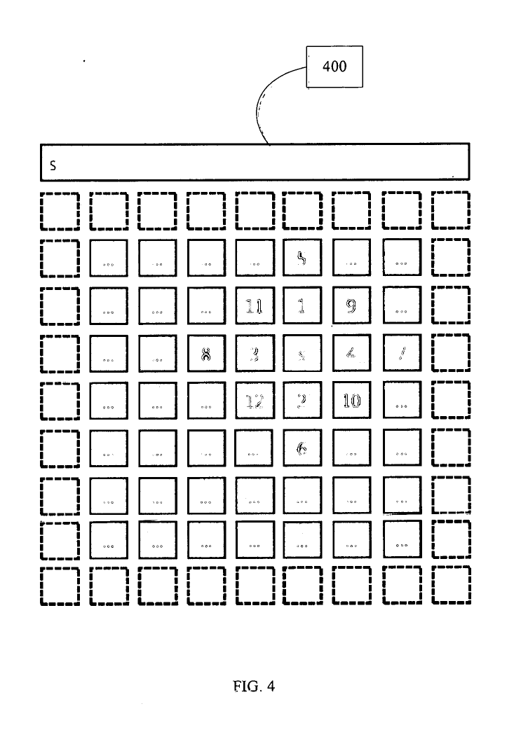

FIG. 4 is an exemplary depiction of ranking logic which places the plurality of probable characters or set of one or more characters or another set of one or more characters towards the center of the virtual grid and adjacent to the central input character in plurality of cells of a virtual square grid 400, in accordance with an embodiment of the present technique. An input as a character is received from an input interface of an input device, wherein each input character act as central character of the virtual square grid. Thereafter a plurality of probable characters or set of one or more characters are arranged towards the center of the virtual grid and adjacent to the central input character based on a ranking logic 204. When user selects any character from the set of one or more characters which are arranged in response to the input character, then virtual grid re-arranges itself with another set of one or more characters which represents another set of one or more probable characters which may form a word as step progresses. According to an exemplary embodiment as mentioned in FIG. 4 400, when character “S” is entered, the characters are ranked based on likelihood of occurrence of next character that is to be clicked. The numbers represents the relevancy or probability of characters which is placed in response to the input character, for instance Number 1 position depicts the most relevant or probable character hence most relevant or probable character after character “S” is placed at position 1. Likewise, position 2 represents character which is less relevant or probable than character placed at position 1 in the grid. Similarly, all the characters are placed based on the probability and likelihood of occurrence next character clicked which enables ease of use of clicking.

In one embodiment, the ranking logic uses dictionary to identify probable characters or prefixes or suffixes or sub-words. For example, in a banana following are the representations:

prefix: “ban” in a banana
suffix: “nana” in banana
sub-word or a sub-string: “ana” in banana

The ranking logic places the probable characters in such a manner that there are equal number of clicks from the center, for different shapes of grid and also based on the different type of interaction by the user. In another embodiment, the ranking logic may be based on one or combination of but not limited to dictionary, mode of interactions by user, predictive text analysis, SMS, twitter, lingo etc.

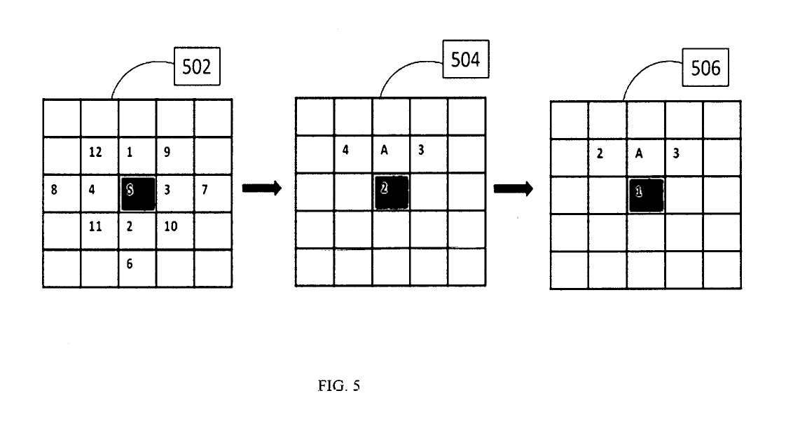

FIG. 5 is an exemplary depiction of an interaction point of each input character as center in an exemplary square virtual grid, in accordance with an embodiment of the present technique.

In a preferred embodiment, the input characters are always placed at the direction leading to center of the virtual grid, in order to maintain the equilibrium of the layout and to minimize actions or number of clicks. Hence the interaction point is always pulled at center of the virtual grid. The interaction point is the point wherein a user interacts with the character or the one or more characters in order to choose a desired letter or word.

The virtual grid accommodate the characters, the prefixes and suffixes and sub-words, based on likelihood of occurrence, to minimize actions or number of clicks. In an instance, when a user selects a required character which is not at the center of the grid, then the ranking logic rearranges the virtual grid in such a manner that, a next probable character occurs to center of the virtual grid. Assuming “S” as input character (502) and character “A” being most probable character positioned at position 1 (504), if same rank positioning as “S” is used, the number of clicks to reach the bottom most character increases by 1 and keep on incrementing as user keeps selecting characters above its location hence new positioning is introduced to bring focus back to center 506 wherein the most probable character is placed at the cell below A's cell.

In a further embodiment, the process also involves eliminating redundant characters from the gird. For instance, if the word to be formed is ‘cricket’ and the input so far is ‘crick’, as per dictionary only possibilities of next alphabet are ‘s’ and ‘e’. Hence, all other characters from the grid would be dropped.

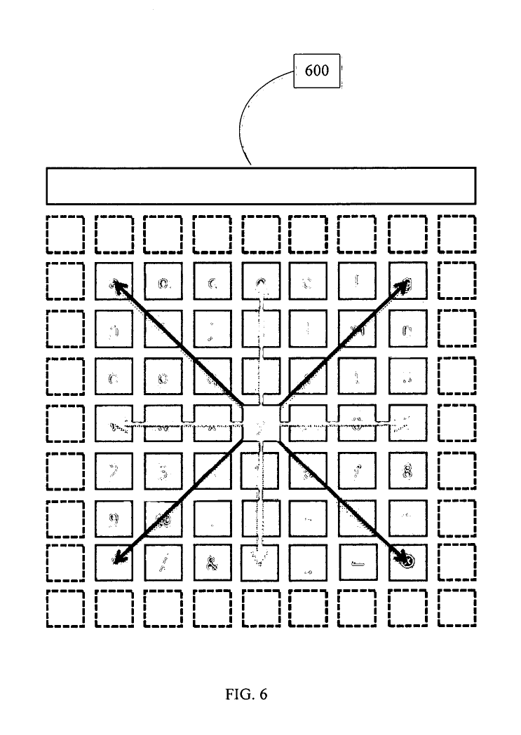

FIG. 6 is an exemplary square grid which depicts equal number of clicks from center of the square grid, in accordance with an embodiment of the present technique 600. The grid as shown in FIG. 6 is balanced in such a way as to ensures equal number of clicks from center for
All worst case (more distance)
All best case (single click)

A ranking logic places the plurality of probable characters or the set one or more of characters and the another set of one or more characters at a specific distance from the central input character. The specific distance is not limited to Chebyshev distance or Euclidean distance or placing characters based on probability in a sort of spiral moving inside out or equidistance. As shape of grid is not limited to square, the specific distances are maintained to ensure equal number of clicks from the center for different shapes of grid. The shape of grid varies with the shape of input device.

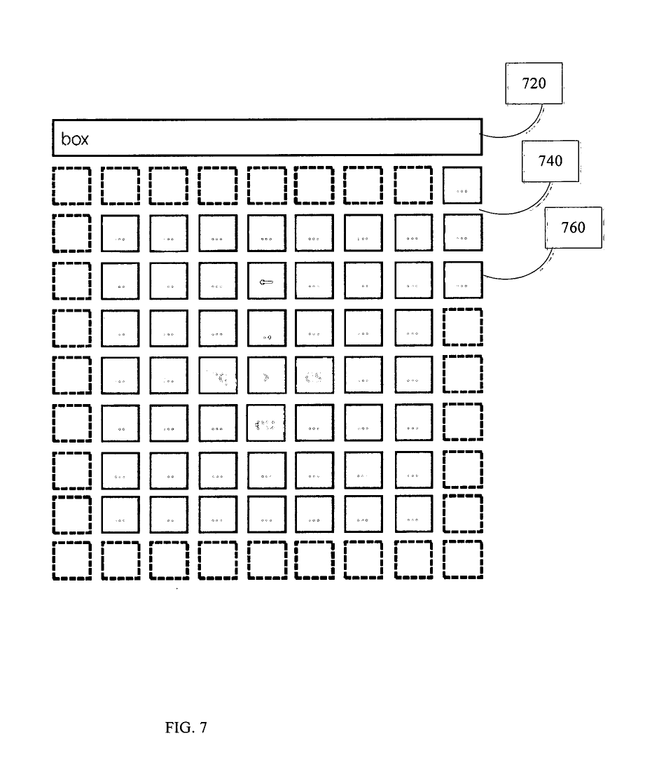

FIG. 7 is an exemplary square virtual grid predicting plurality of suffixes and placing the suffixes in the blank cells of the square virtual grid in response to the input characters, in accordance with an embodiment of the present technique. For instance, if three characters “BOX” has been inputted the probable suffixes are “ing”, “es” or “ed” which are placed in blank cell 720, 740 and 760 respectively. In one embodiment, the present technique also involves prefixes prediction. The prefix and suffix prediction is done based on dictionary.

The central input character represents the character which is placed in the cells of grid in such a manner that the distance of character is equal hence reduces number of clicks. The virtual grid may be adapted for any kind and shape of input device.

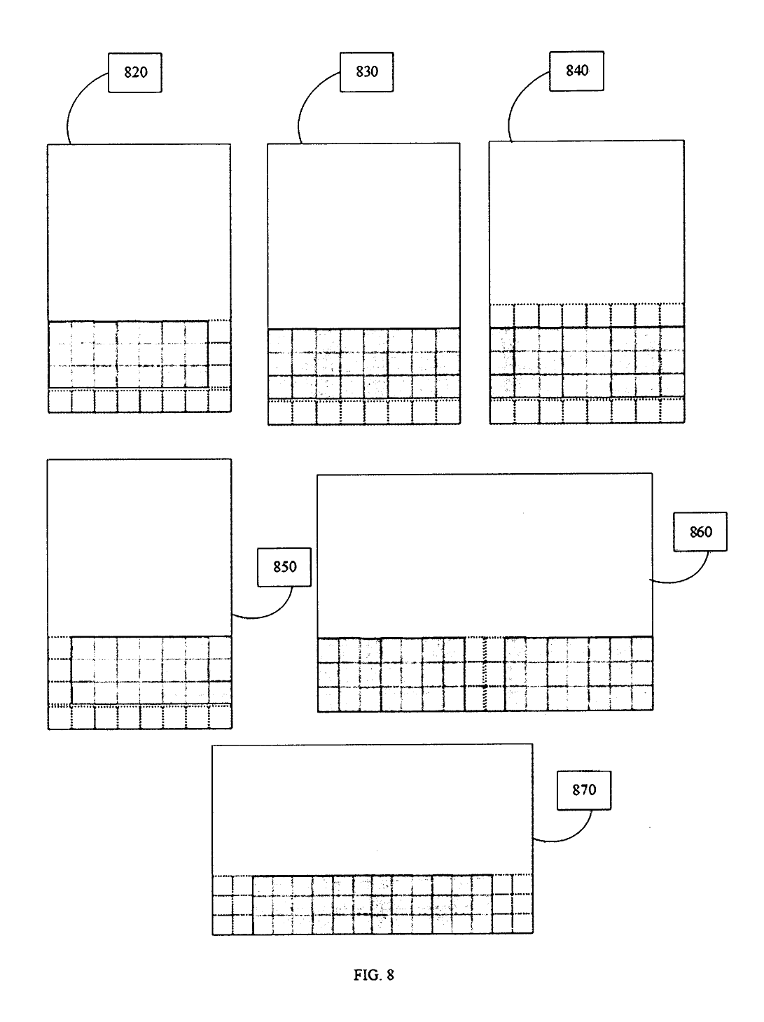

FIG. 8 is an exemplary layouts depicting placement of blank cell depending upon type of device and mode of interaction by user, in accordance with an embodiment of the present technique.

In 810, the figure depicts placement of blank cells in a scenario wherein a mobile handset user is a right hand user and holding the device and keying in the input from the same hand. Similarly 820 depicts mobile handset blank cell placement wherein a user is a left hand user holding the device and keying in the input from the same hand. In 830 the figure depicts the placement of blank cell wherein mobile handset user uses both hand use and a larger screen. In 840 the figure depicts the placement of blank cell wherein mobile handset user uses both hand use and a small screen. In 850 the figure depicts the placement of blank cell wherein the layout is landscape for instance, in tablet where both hand are in use. In 860 the figure depicts the placement of blank cell wherein user is holding the device with one hand and typing with other hand for instance, in tablet. The blank cells are placed in the grid in such a manner that a balance is built on keyboard depending upon the type of input.

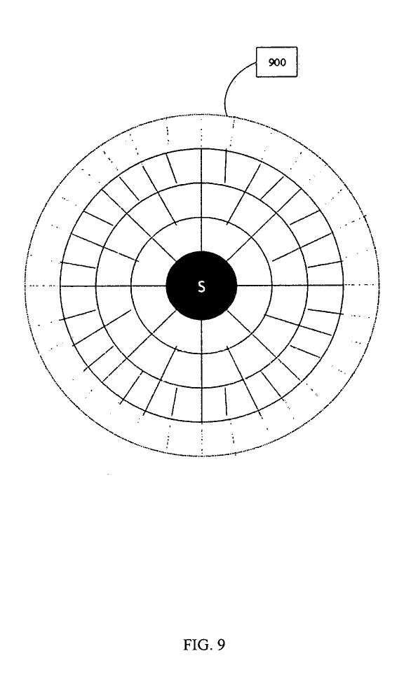

FIG. 9 depicts an exemplary layout of a circular keyboard, in accordance with an embodiment of the present technique 900. According to shape of the keyboard placement of the characters differs. The shape of keyboard is not limited to square, circular, rectangular etc.

In a preferred embodiment, the input device also provides an option to enter a desired character if the arranged characters are not relevant. In a scenario, when the probable characters shown are not relevant to the word which a user desire to enter like regional word, different language word etc., in such cases the user may get the option to display or switch to the initial or specific arrangement of virtual grid presented initially, to enter the desired character.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A method for facilitating electronic inputs comprising:
arranging, by the dynamic input device, an input character as a central character of a virtual grid;
arranging, by the dynamic input device, a set of one or more characters towards the center of the virtual grid and adjacent to the central character based on a ranking logic;
selecting, by the dynamic input device, a required character from the set of one or more characters in the virtual grid and replacing the required character as the central character of the virtual grid;
arranging, by the dynamic input device, another set of one or more characters towards the center of the virtual grid based on the ranking logic; and
repeating, by the dynamic input device, the arranging the input character, arranging the set of one or more characters, selecting, and arranging the another set of one or more characters steps until a predefined word is formed.

2. The method as claimed in claim 1 wherein the input character comprises one or more of an alphabet, number, function key, or special key.

3. The method as claimed in claim 1 wherein the arranging further comprises allocating one or more ranks to a plurality of characters, words, or sub-words associated with the input character.

4. The method as claimed in claim 3, wherein the arranging further comprises placing the set of one or more of characters and the another set of one or more characters at a specific distance from the central input character based on the allocated rank.

5. The method as claimed in claim 1, further comprising predicting, by the dynamic input device, one or more prefixes, suffixes, or sub-words in response to the input character.

6. The method as claimed in claim 1 further comprising eliminating, by the dynamic input device, one or more redundant characters from the virtual gird.

7. A dynamic input device for providing an input comprising:
one or more processors; and
one or more memories operatively coupled to at least one of the one or more processors and having instructions stored thereon that, when executed by at least one of the one or more processors, cause the at least one of the one or more processors to:
arrange an input character as a central character of a virtual grid;
arrange a set of one or more characters towards the center of the virtual grid and adjacent to the central character based on a ranking logic;
select a required character from the set of one or more characters in the virtual grid and replace the required character as the central character of the virtual grid;
arrange another set of one or more characters towards the center of the virtual grid based on the ranking logic; and
repeat the arranging the input character, arranging the set of one or more characters, selecting, and arranging the another set of one or more characters steps until a predefined word is formed.

8. The dynamic input device as claimed in claim 7 wherein the input character comprises one or more of an alphabet, number, function key, or special key.

9. The dynamic input device as claimed in claim 7 wherein the instructions, when executed by the at least one of the one or more processors, further cause the at least one of the one or more processors to allocate one or more ranks to a plurality of characters, words, or sub-words associated with the input character.

10. The dynamic input device as claimed in claim 7, wherein the instructions, when executed by the at least one of the one or more processors, further cause the at least one of the one or more processors to place the set of one or more of characters and the another set of one or more characters at a specific distance from the central input character based on the allocated rank.

11. The dynamic input device as claimed in claim 7, wherein the instructions, when executed by the at least one of the one or more processors, further cause the at least one of the one or more processors to predict one or more prefixes, suffixes, or sub-words in response to the input character.

12. The dynamic input device as claimed in claim 7 wherein the instructions, when executed by the at least one of the one or more processors, further cause the at least one of the one or more processors to eliminate one or more redundant characters from the virtual gird.

13. At least one non-transitory computer-readable medium storing computer-readable instructions that, when executed by one or more computing devices, cause at least one of the one or more computing devices to:
arrange an input character as a central character of a virtual grid;
arrange a set of one or more characters towards the center of the virtual grid and adjacent to the central character based on a ranking logic;
select a required character from the set of one or more characters in the virtual grid and replace the required character as the central character of the virtual grid;
arrange another set of one or more characters towards the center of the virtual grid based on the ranking logic; and
repeat the arranging the input character, arranging the set of one or more characters, selecting, and arranging the another set of one or more characters steps until a predefined word is formed.

14. The at least one non-transitory computer-readable medium of claim 13 wherein the input character comprises one or more of an alphabet, number, function key, or special key.

15. The at least one non-transitory computer-readable medium of claim 13 wherein the computer-readable instructions, when executed by the one or more computing devices, cause the at least one of the one or more computing devices to allocate one or more ranks to a plurality of characters, words, or sub-words associated with the input character.

16. The at least one non-transitory computer-readable medium of claim 13, wherein the computer-readable instructions, when executed by the one or more computing devices, cause the at least one of the one or more computing devices to place the set of one or more of characters and the another set of one or more characters at a specific distance from the central input character based on the allocated rank.

17. The at least one non-transitory computer-readable medium of claim 13, wherein the computer-readable instructions, when executed by the one or more computing devices, cause the at least one of the one or more computing devices to predict one or more prefixes, suffixes, or sub-words in response to the input character.

18. The at least one non-transitory computer-readable medium of claim 13, wherein the computer-readable instructions, when executed by the one or more computing devices, cause the at least one of the one or more computing devices to eliminate one or more redundant characters from the virtual gird.
